(19) United States
(12) Patent Application Publication
(10) Pub. No.: US 2017/0005724 A1
(43) Pub. Date: Jan. 5, 2017

(54) STATION-SIDE DEVICE AND PON SYSTEM

(71) Applicant: MITSUBISHI ELECTRIC CORPORATION, Tokyo (JP)

(72) Inventors: Hideki NOSE, Chiyoda-ku (JP); Ken MURAKAMI, Chiyoda-ku (JP)

(73) Assignee: Mitsubishi Electric Corporation, Chiyoda-ku (JP)

(21) Appl. No.: 15/114,346

(22) PCT Filed: Apr. 25, 2014
(86) PCT No.: PCT/JP2014/061726

§ 371 Date: Jul. 26, 2016

(51) Int. Cl. H04B 10/079; H04J 14/08; H04B 10/272

(52) U.S. Cl. CPC H04B 10/0793; H04B 10/272; H04B 10/0795; H04J 14/08

(57) ABSTRACT

A station-side device includes: an ONU connection processing unit to calculate a connection distance with each one of a plurality of subscriber devices, and to output information about the connection distances; and a bandwidth controller to alter a grant cycle, which is a cycle of performing bandwidth allocation to the plurality of subscriber devices in accordance with information about the connection distances the ONU connection processing unit outputs, and to control bandwidth allocation on the basis of the grant cycle altered.

### TECHNICAL FIELD

The present invention relates to a station-side device (referred to as OLT: Optical Line Terminal, from now on) that performs bandwidth allocation to a plurality of subscriber devices (referred to as ONU: Optical Network Unit, from now on) connected to the OLT via an optical divider and optical fibers, and to a PON (Passive Optical Network) system which is an optical communication network comprised of a single OLT and a plurality of ONUs.

### BACKGROUND ART

A PON system is a point-to-multipoint network system with a single OLT and a plurality of ONUs connected via a passive optical divider such as an optical splitter. A downstream signal from the OLT to the ONUs is transmitted to the optical divider through a single trunk optical fiber, is divided with the optical divider, and is sent to all the ONUs via branch optical fibers. In addition, an upstream signal from each ONU to the OLT is sent from each ONU to the optical divider via a branch optical fiber, and is transmitted from the optical divider to the OLT through the single trunk optical fiber. The control of the PON system is standardized by IEEE 802.3av or IEEE Std 802.3-2008, for example.

As a feature of the point-to-multipoint network of the PON system, it employs a TDM (Time Division Multiplexing) technique, and there is a GE-PON (Gigabit Ethernet (registered trademark) PON) system as one of the examples.

Such a conventional PON system transmits communication frames of different applications such as audio, data and video as application services through the same transmission line. Generally speaking, however, communication requisites for the applications differ from each other. For example, although the requisites for the audio communication are severe as to the frame discard and frame transfer delay, the requisites for the data communication are not so severe as those for the audio communication. To carry out fine control of the individual applications with such different communication requisites, the conventional PON system performs bandwidth control such as dynamic bandwidth allocation (DBA).

For example, a Patent Document 1 discloses a technique that classifies ONUs into short distance ONUs, middle distance ONUs, and long distance ONUs in accordance with transmission distances of optical fibers between the OLT and ONUs, and that performs bandwidth control of the short distance ONUs using a gate-report method, allocates to the middle distance ONUs a fixed bandwidth and the difference (surplus bandwidth) between the bandwidth allocated to the short distance ONUs and the bandwidth actually used for the short distance ONUs, and performs bandwidth control of the long distance ONUs in accordance with the transmission distance by allocating a fixed bandwidth, thereby improving the utilization rate of the bandwidth.

### PRIOR ART DOCUMENT

### Patent Document

Patent Document 1: Japanese Patent Laid-Open No. 2012-49942.

### Non-Patent Document

Non-Patent Document 1: IEEE Std 802.3-2008.
Non-Patent Document 2: IEEE 802.3av.

### DISCLOSURE OF THE INVENTION

### Problems to be Solved by the Invention

As for audio telephone messages and online games requiring real time characteristics of communication, operational stability increases with the reduction in delay time.

However, since the conventional PON system allocates the bandwidth at every prescribed grant cycle determined at a system operation, it has a problem of bringing about data transfer delay corresponding to the grant cycle determined at the system operation.

The present invention is implemented to solve the foregoing problems. Therefore it is an object of the present invention to provide a station-side device capable of improving real time characteristics of communication by optimizing communication delay time of a signal and by reducing an upstream data communication delay time in accordance with connection distances between the OLT and ONUs of the PON system, and to provide a PON system with the station-side device.

### Means for Solving the Problems

To accomplish the foregoing objects, a station-side device in accordance with the present invention comprises in a station-side device connected to a plurality of subscriber devices through optical fibers: an ONU connection processor to calculate a connection distance to each one of the plurality of subscriber devices, and to output information about the connection distances; and a bandwidth controller to alter a grant cycle, which is a cycle of performing bandwidth allocation to the plurality of subscriber devices, in accordance with the information about the connection distances the ONU connection processor outputs, and to control the bandwidth allocation on the basis of the grant cycle altered.

### Advantages of the Invention

According to the present invention, it alters the grant cycle in accordance with the connection distances to the ONUs connected to the OLT, thereby being able to optimize the communication delay time of the signal. In addition, it reduces the upstream data communication delay time in accordance with connection distances between the OLT and ONUs of the PON system, thereby being able to improve the real time characteristics of the communication.

### BRIEF DESCRIPTION OF THE DRAWINGS

FIG. 1 is a diagram illustrating a configuration of a TDM scheme of a PON system in a point-to-multipoint network, and a transmit operation of upstream signals from ONUs to OLT;

FIG. 2 is a diagram illustrating a dynamic bandwidth allocation method of a reference example;

FIG. 3 is a block diagram showing a configuration of a PON system provided with an OLT of an embodiment 1 in accordance with the present invention;

FIG. 4 is a flowchart illustrating the operation of grant cycle alteration in the OLT of the embodiment 1 in accordance with the present invention;

FIG. 5 is a diagram illustrating a relationship between a minimum grant cycle, which is determined in such a manner as to enable the ONU with the maximum connection distance to execute the bandwidth allocation, and the transmission delay time;

FIG. 6 is a block diagram showing a configuration of a PON system provided with an OLT of an embodiment 2 in accordance with the present invention; and

FIG. 7 is a flowchart illustrating the operation of the grant cycle alteration in the OLT of the embodiment 2 in accordance with the present invention.

### BEST MODE FOR CARRYING OUT THE INVENTION

The best mode for carrying out the invention will now be described with reference to the accompanying drawings.

### Embodiment 1

First, a PON system of a reference example will be described with reference to a drawing.

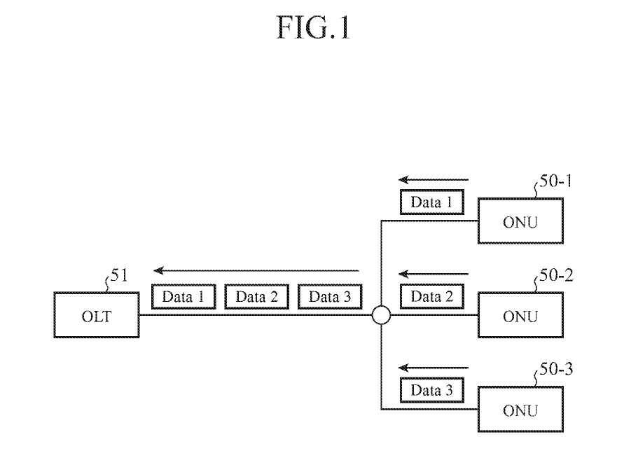

FIG. 1 is a diagram illustrating a configuration of a TDM scheme of a PON system in a point-to-multipoint network, and a transmit operation of upstream signals from ONUs 50-1-50-3 to an OLT 51. Incidentally, although it is assumed that the number of the ONUs 50-1-50-3 is three here, it is not limited to that.

As shown in FIG. 1, when the plurality of ONUs 50 (ONUs 50 refers to all the ONUs) transmit their signals simultaneously, a collision between signals sent from the ONUs 50 occurs so that the OLT 51 cannot receive the signals correctly. To prevent such an interference between the signals, as for the upstream signals sent from the ONUs 50 to the OLT 51, the PON system of the reference example shown in FIG. 1 has to carry out time division transmission in a limited bandwidth. Thus, it adds to each one of the ONUs 50 an identifier called LLID (Logical Link Identifier) which is a unique number for identifying each one of the ONUs 50 in advance, sends information about the transmission timing of the signal from the OLT 51 to each one of the ONUs 50 using the LLID, and controls so as to prevent the collision, thereby carrying out control that enables the OLT 51 to receive data normally by preventing the interference between the signals by adjusting the transmission timing of each one of the ONUs 50 in such a manner as to avoid overlap of the transmission timing.

In addition, as for a downstream signal sent from the OLT 51 to the ONUs 50, since it is transmitted through a single trunk optical fiber and then divided with an optical divider to be delivered to all the ONUs 50, each one of the ONUs 50 refers to the LLID in the preamble of a frame transmitted, and captures the frame if the LLID agrees with the LLID of itself, but discards the frame if it does not agree.

The PON system of the reference example transmits, as its application service, communication frames of different applications such as audios, data and videos through the same transmission line. In general, however, communication requisites for applications differ depending on the applications. For example, audio communication has more severe requisites as to the frame discard and frame transfer delay, but data communication has less severe requisites than the audio communication. To achieve fine control for each of the applications with such different communication requisites, it is preferable that the PON system perform mapping of an application for each LLID, and carry out control considering the delay time and transmission bandwidth for each LLID. As for the LLID for transferring the audio communication with more severe communication requisites, for example, the PON system performs a transmission cyclic operation considering the delay time and the allocation of a minimum guaranteed bandwidth to maintain a bandwidth required, thereby curbing the frame discard and achieving the audio quality with small delay. As for the LLID for transferring the data communication, however, it does not allocate the minimum guaranteed bandwidth, sets only the maximum bandwidth that is not guaranteed, and carries out frame transfer using a surplus bandwidth other than the bandwidths used by the other applications.

As a method of realizing such bandwidth control, there is a dynamic bandwidth allocation (DBA).

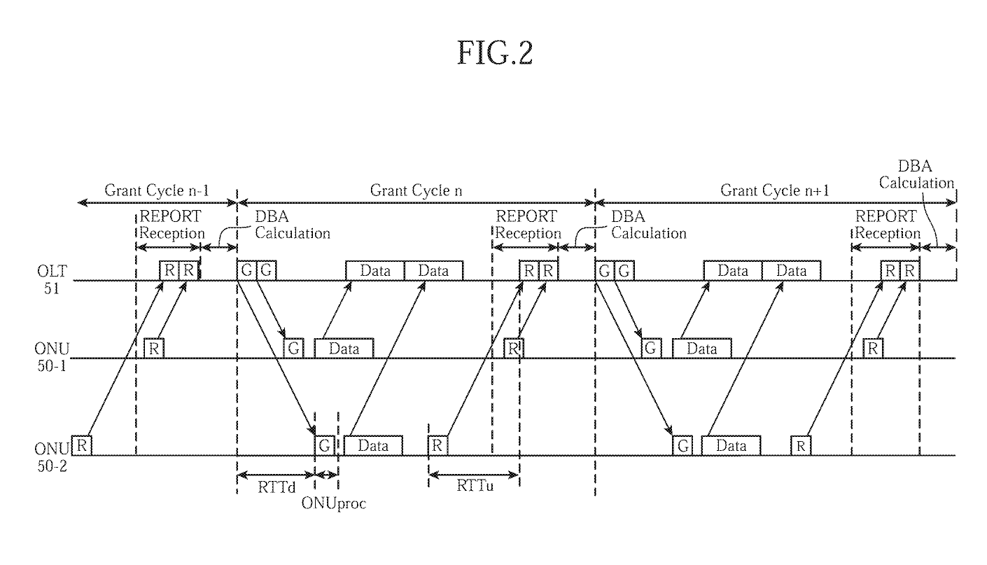

FIG. 2 is a diagram illustrating a dynamic bandwidth allocation method of the reference example. Incidentally, for a simplification of explanation, FIG. 2 shows an example with two ONUs 50-1 and 50-2 connected.

The control method of the bandwidth allocation based on the DBA adds up the total of traffic volumes from the OLT 51 to the ONUs 50, and allocates communication bandwidths considering the traffic volumes.

Allocating the bandwidths by the OLT 51 enables the traffic sent from each one of the ONUs 50 to achieve its communication without interference.

The information about traffic volumes sent from the ONU 50-1 and ONU 50-2 to the OLT 51 is given by sending a report frame from the ONUs 50 to the OLT 51. The bandwidth allocation of the OLT 51 to the ONU 50-1 and ONU 50-2 is made by sending a gate frame from the OLT 51 to the ONUs 50.

Incidentally, the report frame and gate frame are formed in accordance with a frame format defined by IEEE Std 802.3-2008 or IEEE 80.3av.

Exchange of report frames and gate frames is performed by repeating the operation as shown in FIG. 2. In FIG. 2, the ONUs 50-1 and 50-2 notify the OLT 51 about their upstream traffic volumes they store by means of a report (denoted by “R” in FIG. 2).

The OLT 51 maintains a time slot for receiving the report from each one of the ONUs 50, and receives the reports from all the ONUs. After that, the OLT 51 determines the bandwidth to be allocated to the ONU 50-1 or 50-2.

The bandwidth allocation is made at every prescribed time interval referred to as the grant cycle. The bandwidth allocated to each one of the ONUs 50 determined here will become the bandwidth allocation in the next grant cycle.

The bandwidth allocation information determined for each one of the ONUs 50 is sent to each of the ONUs 50-1 and 50-2 by means of a gate (denoted by “G” in FIG. 2).

According to the gate information, each of the ONUs 50-1 and 50-2 reads its own upstream data transmission start time and data transmit volume in the next grant cycle, and starts transmitting the report frame and upstream data when the time designated by the OLT 50 comes.

The gate information the OLT transmits considers the propagation time based on the transmission distance of an optical fiber from the OLT 51 to the ONU 50-1 or ONU 50-2, and the processing time from receiving the gate at each one of the ONUs 50 to a transmission start time waiting state (ONU internal processing time: ONU proc), so that each one of the ONUs 50 operates in such a manner as to prevent them from interfering with each other.

The propagation time based on the transmission distance of the optical fiber from the OLT 51 to the ONU 50-1 or ONU 50-2, and the processing time from receiving the gate at each one of the ONUs 50 to the transmission start time waiting state (ONU internal processing time: ONU proc) are referred to as RTT (Round Trip Time) (the total value of the RTTd and RTTu of FIG. 2).

Carrying out an upstream communication by exchanging a gate and report enables each ONU to execute processing of burst data transmission at every grant cycle.

Thus, the cycle of performing the burst data transmission depends on the grant cycle, and the grant cycle is one of the factors for an occurrence of data transfer delay time. In other words, the PON system such as a reference example has a problem of always bringing about the data transfer delay equal to the grant cycle determined at the system operation.

The object of the OLT 51 and PON system in accordance with the present invention is to solve such a problem.

The OLT 51 and PON system of the embodiment 1 in accordance with the present invention will be described with reference to the drawings.

Incidentally, the individual drawings give an outline to such an extent that will enable understanding the present invention. Accordingly, the present invention is not limited to examples shown by the drawings

Incidentally, in the drawings, common components or like components are designated by the same reference symbols and their duplicate description will be omitted.

In addition, in the following description, a GE-PON is used as an example of the PON system using the TDM scheme.

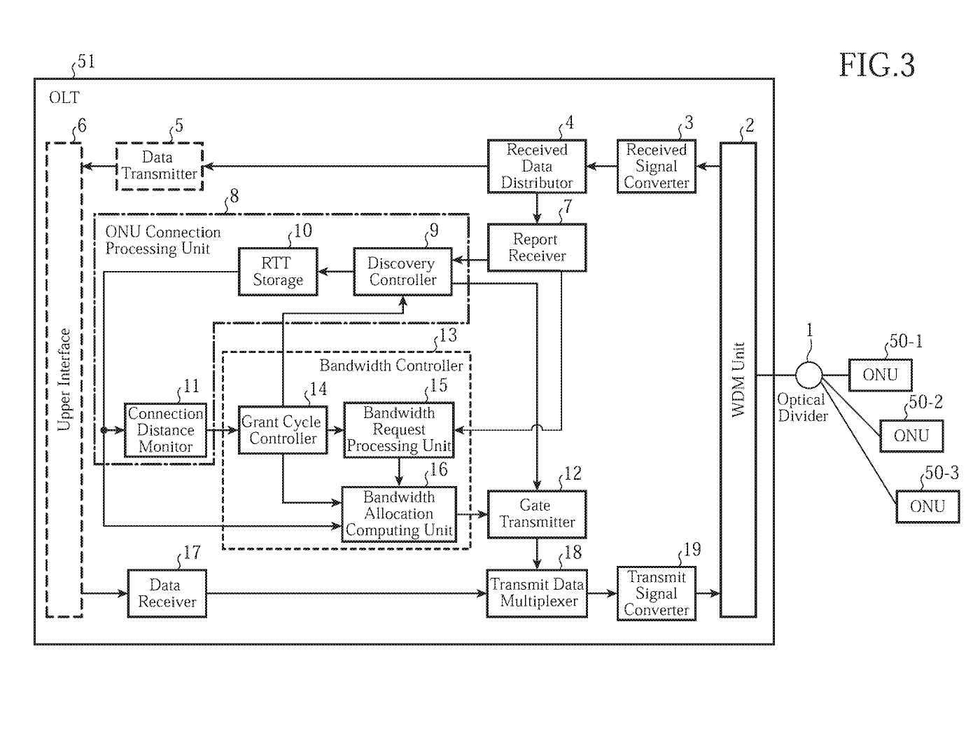

FIG. 3 is a block diagram showing a configuration of a PON system with an OLT 51 of the embodiment 1 in accordance with the present invention.

As shown in FIG. 3, the PON system of the embodiment 1 has the OLT 51 and a plurality of ONUs (50-1, 50-2, . . . ) connected via optical fibers through an optical divider 1. Incidentally, although FIG. 3 supposes three ONUs 50, the number of the ONUs is not limited to three.

The OLT 51 is a station-side device installed in a communication carrier, and the plurality of ONUs (50-1, 50-2, . . . ) are a plurality of subscriber devices installed at subscriber's homes. In addition, the OLT 51 is connected to a WAN (Wide Area Network), the Internet or a variety of servers via an upper interface 6 of the OLT 51.

The OLT 51 comprises a WDM (Wavelength Division Multiplexing) unit 2, a received signal converter 3, a received data distributor 4, a data transmitter 5, an upper interface 6, a report receiver 7, an ONU connection processing unit 8, a gate transmitter 12, a bandwidth controller 13, a data receiver 17, a transmit data multiplexer 18, and a transmit signal converter 19.

The WDM unit 2 multiplexes optical signals in upstream and downstream directions.

The received signal converter 3 converts data received from the ONUs 50 to an electric signal.

The received data distributor 4 separates a report frame and data from the upstream data received from the ONUs 50.

The data transmitter 5 sends the data it receives from the received data distributor 4 to the upper interface 6.

The upper interface 6 is a physical interface for connecting the OLT to the upper network.

The report receiver 7 notifies the ONU connection processing unit 8 and the bandwidth controller 13 of the report frame it receives from the received data distributor 4, that is, a bandwidth allocation request.

The ONU connection processing unit 8 executes connection processing with the ONUs 50 (its details will be described later).

The gate transmitter 12 sends the bandwidth allocation information the bandwidth controller 13 determines to the transmit data multiplexer 18.

The bandwidth controller 13, which is a controller that executes DBA, controls the upstream bandwidth allocation to each one of the ONUs 50 (its details will be described later).

The data receiver 17 receives the data the upper interface 6 receives.

The transmit data multiplexer 18 sends frames it receives from the gate transmitter 12 and data receiver 17 to the transmit signal converter 19.

The transmit signal converter 19 converts a transmit data electric signal to an optical signal.

The ONU connection processing unit 8 is comprised of a discovery controller 9, an RTT storage 10, and a connection distance monitor 11.

The discovery controller 9 checks the connectivity between the OLT 51 and each one of the ONUs 50 (discovery processing).

Incidentally, the discovery processing the discovery controller 9 carries out is one of the GE-PON functions. It regularly monitors the ONUs 50 connected to the GE-PON network based on a discovery cycle, and when it detects an ONU 50, it sends an acknowledgement signal that it detects the ONU 50 to the gate transmitter 12. The acknowledgement signal is sent to the ONU 50 via the gate transmitter 12, transmit data multiplexer 18, transmit signal converter 19, and WDM unit 2. In addition, after sending the acknowledgement signal, that is, a confirmation frame to the ONU 50, the discovery controller 9 measures the time (RTT) until it receives a response signal from the ONU 50, and notifies the RTT storage 10 of the RTT value. Incidentally, at this time, the discovery controller 9 provides each one of the ONUs 50 with a unique LLID, and notifies the RTT storage 10 of the LLIDs together with the RTT values. In addition, when the discovery controller 9 relinquishes the connection with an ONU 50, it notifies the RTT storage 10 of the disconnection information as well.

The RTT storage 10 stores the RTT value of each one of the ONUs 50 the discovery controller 9 measures. Incidentally, the RTT storage 10 stores the RTT value the discovery controller measures in association with the LLID of the ONU 50 the RTT storage 10 acquires from the discovery controller 9.

In addition, when the discovery controller 9 breaks the connection with an ONU 50, the RTT storage 10 retains the disconnection information, and sends the disconnection information to the connection distance monitor 11. Incidentally, the RTT storage 10 can be configured in such a manner that it does not retain the disconnection information, but deletes the information about the ONU 50 and sends the disconnection information to the connection distance monitor 11 at the same time.

The connection distance monitor 11 calculates the connection distances of the connected ONUs 50 in accordance with the information about the RTT values the RTT storage 10 stores, and determines the maximum connection distance among the ONUs 50 connected. Incidentally, the connection distance monitor 11 makes a list of the connection distances of the ONUs 50 it calculates, and retains the list as an ONU connection distance list so that it can maintain the maximum connection distance among the ONUs 50 connected.

In a state where the plurality of ONUs 50 are connected, when the connection distance monitor 11 receives from the RTT storage 10 the information that part of the connections with the ONUs 50 is released, it monitors whether the maximum connection distance among the ONUs 50 that have established the connections changes or not, and if it changes, the connect ion distance monitor 11 sends the information that the maximum connection distance changes and the maximum connection distance after the change to a grant cycle controller 14 of the bandwidth controller 13.

The bandwidth controller 13 is comprised of the grant cycle controller 14, a bandwidth request processing unit 15, and a bandwidth allocation computing unit 16.

The grant cycle controller 14 determines a grant cycle (bandwidth allocation cycle) time in accordance with the information on the maximum connection distance sent from the connection distance monitor 11.

As the grant cycle lengthens, the upstream transmission cycle of each one of the ONUs 50 lengthens, and hence the delay time of the upstream data increases. Thus, the grant cycle controller 14 determines the grant cycle time by considering the maximum connection length among the ONUs 50 connected, report receiving time, and DBA calculation time.

In addition, according to the information on the maximum connection distance sent from the connection distance monitor 11, the grant cycle controller 14 reduces the grant cycle in conformity with the maximum connection distance if the maximum connection distance among the ONUs 50 connected reduces with respect to the initial grant cycle preset at a start because of changes of a connection state of the ONUs 50, and the grant cycle controller 14 increases the grant cycle in conformity with the maximum connection distance if the maximum connection distance increases; and delivers the information about the updated grant cycle to the bandwidth request processing unit 15 and bandwidth allocation computing unit 16.

The bandwidth request processing unit 15 collects a bandwidth allocation request from each one of the ONUs 50 by receiving from the report receiver 7 the report sent from each one of the ONUs 50.

In addition, according to the grant cycle information it receives from the grant cycle controller 14, the bandwidth request processing unit 15 supplies the bandwidth allocation computing unit 16 with a bandwidth allocation request of each one of the ONUs 50, which is collected within the report receiving time.

According to a bandwidth allocation request and grant cycle, the bandwidth allocation computing unit 16 transmits the gate signal to each one of the ONUs 50 so as to control the bandwidth allocation time to each one of the ONUs 50 and the upstream data transmit time of each one of the ONUs 50.

More specifically, the bandwidth allocation computing unit 16 sends the information about the upstream signal transmit time and transmit data volume of each one of the ONUs 50 to the ONU 50 via the gate transmitter 12, transmit data multiplexer 18, transmit signal converter 19 and WDM unit 2 on the basis of the grant cycle received from the grant cycle controller 14, the bandwidth allocation request of each one of the ONUs 50 delivered from the bandwidth request processing unit 15, and the LLID number and RTT value of each one of the ONUs 50 received from the RTT storage 10.

Incidentally, if the bandwidth allocation computing unit 16 decides that the ONUs 50 cannot transmit all their bandwidth transmit requests within the grant cycle, it performs priority control so as to carry out a transmit instruction to the ONUs 50.

Although the DBA control has various methods that are applicable appropriately, the present embodiment does not refer to them.

As described above, the OLT 51 achieves the optimization of the delay time of the upstream ONU data in accordance with the configuration as shown in FIG. 3.

Next, the operation of the OLT 51 of the embodiment 1 in accordance with the present invention will be described, which achieves the optimization of the delay time of the ONU data by altering the grant cycle.

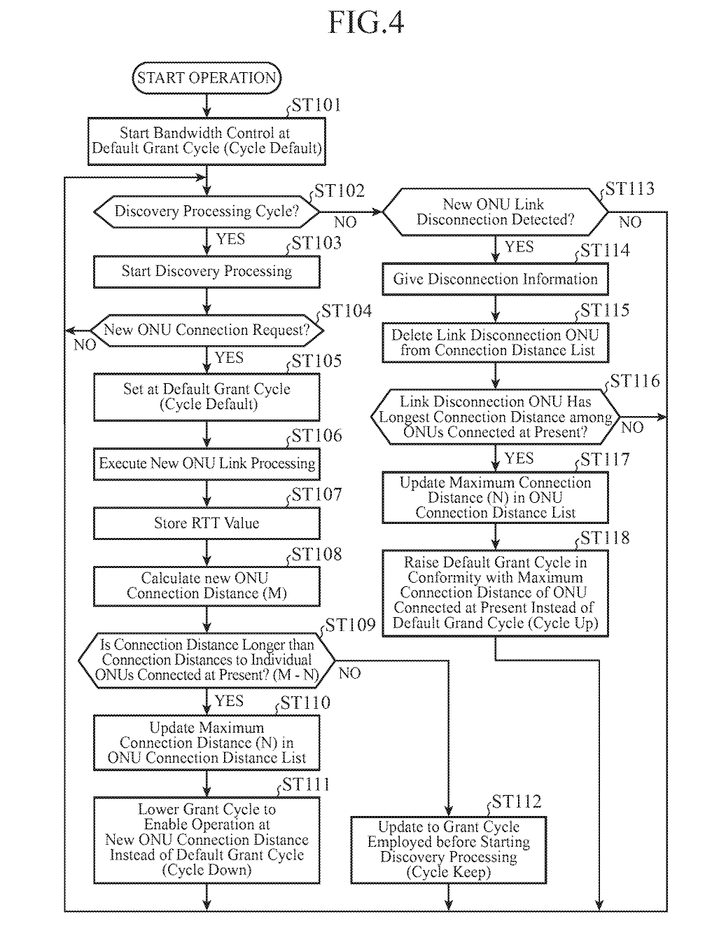

FIG. 4 is a flowchart illustrating the operation of the grant cycle alteration in the OLT 51 of the embodiment 1 in accordance with the present invention.

First, the operation of the GE-PON system is started, and the OLT 51 starts bandwidth control at a preset initial grant cycle (step ST101).

The discovery controller 9 checks whether the cyclic timing is one for executing the discovery processing (step ST102).

If it decides at step ST102 that it is cyclic timing for the discovery processing (“YES” at step ST102), the discovery controller 9 starts the discovery processing (step ST103).

The discovery controller 9 decides whether or not there is an ONU 50 that makes a new connection request or an ONU 50 that alters the connection distance (step ST104). Incidentally, as for the information as to whether the connection distance alters or not, it is assumed that the discovery controller 9 detects it according to the alteration of the response time RTT value when the ONU 50 is connected. Incidentally, it is supposed in the following description that a newly connected ONU includes an ONU 50 that alters the connection distance.

If the discovery controller 9 decides at step ST104 that there is no ONU 50 that makes a new connection request (“NO” at step ST104), it returns to step ST102.

If the discovery controller 9 decides at step ST104 that there is an ONU 50 that makes a new connection request (“YES” at step ST104), since the connection distance of the newly connected ONU 50 is unknown, the discovery controller 9 performs the bandwidth control at the preset grant cycle so as to enable connection with the newly connected ONU 50 (step ST105). More specifically, the discovery controller 9 makes an inquiry at the ONU 50 via the gate transmitter 12, transmit data multiplexer 18, transmit signal converter 19 and WDM unit 2 in accordance with the preset cycle of the grant cycle controller 14, and checks a reply from the ONU 50 through the report receiver 7.

Incidentally, the processing at step ST105 is a temporary processing until the connection distance of the newly connected ONU 50 is calculated by the processing of the discovery controller 9 and connection distance monitor 11 at step ST106 and step ST107 which will be described later, that is, the initial processing when the newly connected ONU 50 is detected.

The discovery controller 9 executes the connection processing (link processing) of the new ONU 50 (step ST106). In other words, it performs the processing of measuring the RTT value of the newly connected ONU 50. Incidentally, the link processing is executed by that the discovery controller 9 receives a timing instruction for performing the discovery processing from the grant cycle controller 14, makes an inquiry at the ONU 50 via the gate transmitter 12, transmit data multiplexer 18, transmit signal converter 19 and WDM unit 2 (by sending an acknowledgement signal that confirms the detection of the newly connected ONU 50), and checks a reply from the ONU 50 through the report receiver 7 (by measuring the time (RTT) until it receives the response signal from the new ONU 50).

The discovery controller 9 assigns a unique LLID to the newly connected ONU 50, notifies the RTT storage 10 of the LLID together with the RTT value it measures at step ST106. The RTT storage 10 stores the unique LLID of the ONU 50 in association with the RTT value assigned (step ST107).

The connection distance monitor 11 calculates the connection distance (M value) to the newly connected ONU 50 in accordance with the RTT value the RTT storage 10 stores at step ST107 (step ST108).

The connection distance monitor 11 decides at step ST108 whether the connection distance to the newly connected ONU 50 is greater than the connection distances to the other ONUs 50 connected at present (step ST109). More specifically, according to the ONU connection distance list formed of the connection distances of the ONUs 50 calculated, the connection distance monitor 11 compares the maximum distance (N value) to the ONUs 50 before detecting the newly connected ONU 50 with the connection distance to the newly connected ONU 50 (M value), and decides whether M−N>0 or not.

At step ST109, if the connection distance to the newly connected ONU 50 is greater than the connection distances to the other ONUs 50 connected at present, that is, if M−N>0 (“YES” at step ST109), the connection distance monitor 11 updates the maximum connection distance (N) in the ONU connection distance list it maintains (step ST110). Then it informs the grant cycle controller 14 of the updated maximum connection distance (N).

The grant cycle controller 14 elongates the set grant cycle (lowers the cycle) in conformity with the newest ONU connection distance informed by the connection distance monitor 11 at step ST110 (the processing is defined as Cycle Down) (step ST111). In other words, the grant cycle controller 14 alters the grant cycle in a manner as to lengthen the grant cycle, and returns to step ST102.

Incidentally, if the grant cycle controller 14 performs the Cycle Down at step ST111, the bandwidth allocation computing unit 16 sends the information about the upstream signal transmit time and transmit data volume of each one of the ONUs 50 to the ONU 50 via the gate transmitter 12, transmit data multiplexer 18, transmit signal converter 19 and WDM unit 2 in accordance with the grant cycle that is received from the grant cycle controller 14 and has undergone the Cycle Down, the bandwidth request of each one of the ONUs 50 informed by the bandwidth request processing unit 15, and the LLID number and RTT value of each one of the ONUs 50 received from the RTT storage 10. Although the DBA control has various methods, since an existing method is applicable appropriately, detailed description thereof will be omitted.

At step ST109, if the connection distance to the newly connected ONU 50 is less than the maximum connection distance among the ONUs 50 connected at present, that is, M−N≦0 (“NO” at step ST109), the connection distance monitor 11 informs the grant cycle controller 14 of the maximum connection distance (N) in the present ONU connection distance list, that is, the maximum connection distance (N) employed in the previous discovery processing, and the grant cycle controller 14 re-sets the set grant cycle which the previous discovery processing employs (the processing is defined as Cycle Keep) (step ST112). Then, it returns to step ST102.

Incidentally, when the grant cycle controller 14 performs the Cycle Keep at step ST112, the bandwidth allocation computing unit 16 executes the DBA control in the same manner as when the grant cycle controller 14 performs the Cycle Down at step ST111 in accordance with the grant cycle which is received from the grant cycle controller 14 and undergoes the Cycle Keep, the bandwidth request of each one of the ONUs 50 informed by the bandwidth request processing unit 15, and the LLID number and RTT value of each one of the ONUs 50 received from the RTT storage 10.

On the other hand, unless the discovery controller 9 decides at step ST102 that the cyclic timing is one for executing the discovery processing (“NO” at step ST102), the discovery controller 9 checks whether a disconnection (link breaking) of an ONU 50 occurs or not (step ST113).

At step ST113, unless the link breaking of the ONU 50 occurs (“NO” at step ST113), the processing returns to step ST102.

At step ST113, if the link breaking of the ONU 50 occurs (“YES” at step ST113), the discovery controller 9 sends the disconnection information to the RTT storage 10, and the RTT storage 10 retains the disconnection information it receives from the discovery controller 9. Then, it notifies the connection distance monitor 11 of the disconnection information (step ST114).

Receiving the disconnection information, the connection distance monitor 11 deletes the information about the ONU 50 from the ONU connection distance list (step ST115).

The connection distance monitor 11 decides whether or not the ONU 50 that has the link breaking, that is, the ONU 50 deleted from the ONU connection distance list at step ST115 has the maximum connection distance among the ONUs 50 connected (step ST116).

At step ST116, if the connection distance is not maximum (“NO” at step ST116), the processing returns to step ST102.

At step ST116, if the connection distance is maximum (“YES” at step ST116), the connection distance monitor 11 updates the maximum connection distance (N) of the ONU 50 connected at present to the second longest connection distance of the ONU 50 after the ONU 50 with the link breaking among the ONU connection distance list it retains (step ST117), and informs the grant cycle controller 14 of the updated maximum connection distance (N).

Then the grant cycle controller 14 shortens the set grant cycle (raises the cycle) in conformity with the newest maximum connection distance (N) informed by the connection distance monitor 11 (the processing is defined as Cycle Up) (step ST118). In other words, the grant cycle controller 14 alters the grant cycle in such a manner as to make the grant cycle shorter. Then, the processing returns to step ST102.

Incidentally, when the grant cycle controller 14 carries out the Cycle Up at step ST118, the bandwidth allocation computing unit 16 performs the DBA control in the same manner as when it performs Cycle Down at step ST111 and Cycle Keep at step ST112 in accordance with the grant cycle which it receives from the grant cycle controller 14 and at which it performs Cycle Up, the bandwidth request of each one of the ONUs 50 informed by the bandwidth request processing unit 15, and the LLID number and RTT value of each one of the ONUs 50 it receives from the RTT storage 10.

Thus, by repeating the operation of FIG. 4, the OLT 51 monitors the maximum connection distance to the ONUs 50 connected, executes as to the grant cycle the cycle extension (Cycle down), grant cycle maintenance (Cycle Keep), and grant cycle reduction (Cycle Up) so as to always minimize the data transfer delay time in conformity with the maximum connection distance.

As described above, the OLT 51 of the embodiment 1 in accordance with the present invention calculates the connection distances to the ONUs (50-1, 50-2, . . . ) connected via the optical fibers, and determines the minimum grant cycle value in such a manner that it can execute bandwidth allocation to the ONU 50 with the maximum connection distance by checking the connection distances to all the ONUs 50 connected. Accordingly, it can reduce the upstream transmission delay time.

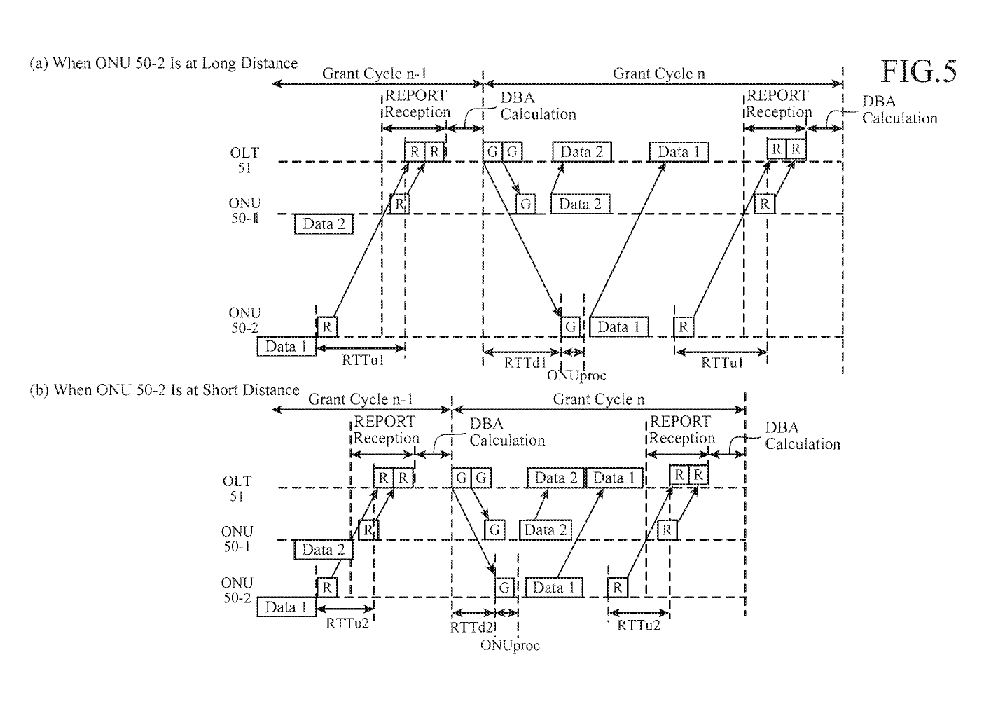

Here, FIG. 5 is a diagram illustrating a relationship between the minimum grant cycle, which is determined in such a manner as to enable the bandwidth allocation to the ONU 50 with the maximum connection distance, and the transmission delay time.

Incidentally, it is assumed in FIG. 5 that the ONU 50-2 is the ONU with the maximum connection distance.

In addition, FIG. 5(a) is a diagram illustrating a flow of the data transfer of data 1 from the ONU 50-2 to the OLT 51 when the ONU 50-2 is at a long distance, and FIG. 5(b) is a diagram illustrating a flow of the data transfer of data 1 from the ONU 50-2 to the OLT 51 when the ONU 50-2 is at a short distance.

In FIG. 5(a), after the data 1 arrives at the ONU 50-2, the ONU 50-2 informs the OLT 51 that the ONU 50-2 retains the data within it using a report frame. At this time, the transfer time for the report and data to arrive at the OLT 51 from the ONU 50-2 via the optical fiber is defined as RTTu1.

After the report receiving time has elapsed which is the duration for receiving the report frames from the individual ONUs, the OLT 51 that receives the report frames executes the DBA calculation for performing the bandwidth allocation to each one of the ONUs 50. Incidentally, the processing so far is performed within the grant cycle n−1.

After the DBA calculation, the OLT 51 transmits a gate frame (gate signal) that instructs each one of the ONUs 50 on the data transmit time and transmit volume in the grant cycle n.

After receiving the gate frame, the ONU 50-2 starts transmitting the data 1 to the OLT 51 in conformity with the transmit assigned time after the ONU internal processing time (ONU proc) has elapsed. At this time, the transfer time for the downstream data to arrive at the ONU 50-2 from the OLT 51 via the optical fiber is defined as RTTd1.

As for the delay time when the grant cycle time is fixed, the foregoing operation brings about the delay corresponding to the grant cycle regardless of the connection distance between the OLT 51 and the ONUs 50.

In the OLT 51 of the present embodiment 1, however, since it determines the minimum grant cycle value in such a manner as to enable the bandwidth allocation to the ONU 50 with the maximum connection distance by confirming the connection distances to all the ONUs 50 connected, it is seen as shown in FIG. 5(b) illustrating the data transfer time when the ONU 50-2 is at a short distance that the OLT 51 can improve the upstream transmission delay time by the amount given by the following expression (1) by shortening the grant cycle as compared with the case of FIG. 5(a).

Timp=RTTu1−RTTu2+RTTd1−RTTd2 (1)

Here, Timp is an upstream data delay reduced time when the connection distance of the ONU 50-2 alters from the long distance to the short distance in the model of FIG. 5.

The RTTu1 is the time for the ONU 50-2 to transfer the report or data to the OLT when it is connected to the long distance in the model of FIG. 5(a), and the RTTu2 is the time for the ONU 50-2 to transfer the report or data to the OLT when it is connected to the short distance in the model of FIG. 5(b).

In addition, the RTTd1 is the time for the OLT 51 to transfer the gate to the ONU 50-2 when the ONU 50-2 is connected to the long distance in the model of FIG. 5(a), and the RTTd2 is the time for the OLT 51 to transfer the gate to the ONU 50-2 when the ONU 50-2 is connected to the short distance in the model of FIG. 5(b).

The transmission speed of the optical fiber is about 5 ns/m. Thus, when the connection distance of the ONU 50-2 at the long distance is altered from 20 km to 10 km, for example, improvement of about 100 microseconds can be expected from Expression (1) by altering the grant cycle.

As for the operation described with reference to FIG. 5, although it is explained by using an example in which the connection distance to the ONU 50 with the longest connection distance is altered, it goes without saying that even when the ONU 50 with the longest connection distance has a link breaking or is removed, and then is replaced by an ONU 50 with a different maximum connection distance, the transmission delay time is improved by altering the grant cycle. In addition, it goes without saying that when an ONU 50 with the longest connection distance is newly connected, the optimization of the transmission delay time can be achieved by altering the grant cycle.

As described above, according to the station-side device (OLT 51) of the present embodiment 1, it alters the grant cycle in accordance with the transmission distances of the ONUs 50 connected the OLT 51, thereby being able to optimize the communication delay time of the signal. In addition, it reduces the upstream data communication delay time in accordance with the connection distance between the OLT 51 and the ONUs 50 of the PON system, thereby being able to improve the real time characteristics of the communication.

### Embodiment 2

In the embodiment 1, the discovery controller 9 is configured in such a manner that when it detects the connection with the ONUs 50, it enables the connection regardless of the connection distance, makes a decision whether it becomes the maximum connection distance or not, and performs the DBA control. In the present embodiment 2, however, a configuration will be described which sets an upper limit to the connection distances to the ONUs 50 connected.

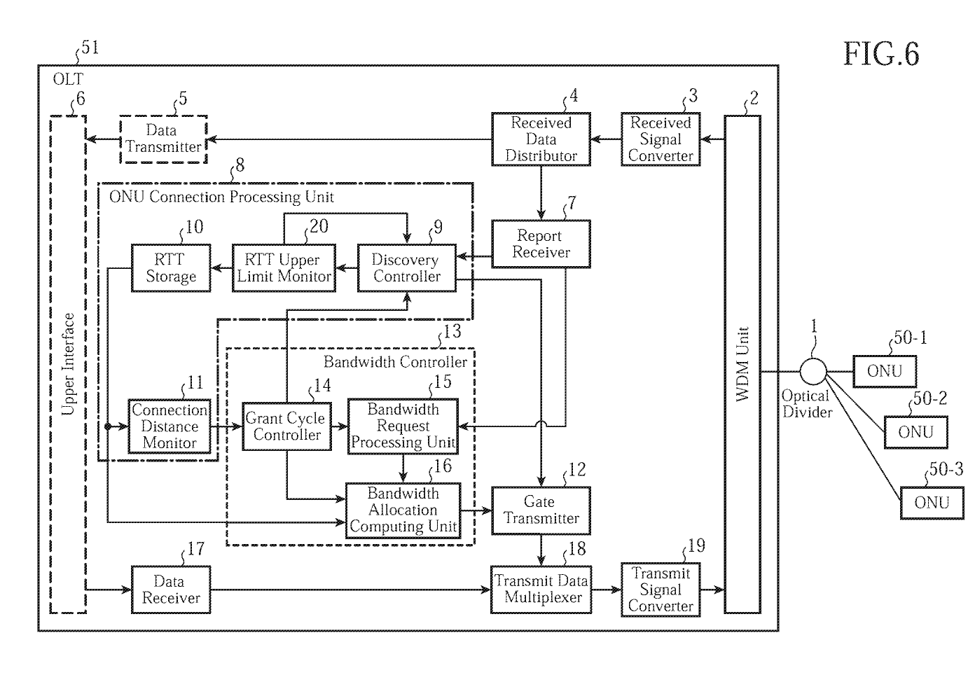

FIG. 6 is a block diagram showing a configuration of a PON system including an OLT 51 of the embodiment 2 in accordance with the present invention.

Incidentally, in FIG. 6, the same components as those described with reference to FIG. 1 in the embodiment 1 are designated by the same reference symbols, and their redundant description will be omitted.

FIG. 6 differs from FIG. 1 in that the OLT 51 further comprises an RTT upper limit monitor 20.

The RTT upper limit monitor 20 checks whether the connection distance to a new ONU 50 the discovery controller 9 detects is within an upper limit of the connection distance between the OLT 51 and the ONUs 50. Incidentally, it is assumed that the upper limit of the connection distance between the OLT 51 and the ONUs 50 the RTT upper limit monitor 20 checks is based on the RTT value, and is set in advance by the GE-PON system.

In addition, if an ONU 50 is connected which exceeds the upper limit of the connection distance between the OLT 51 and the ONUs 50, the RTT upper limit monitor 20 sends alarm output information to an output unit (not shown).

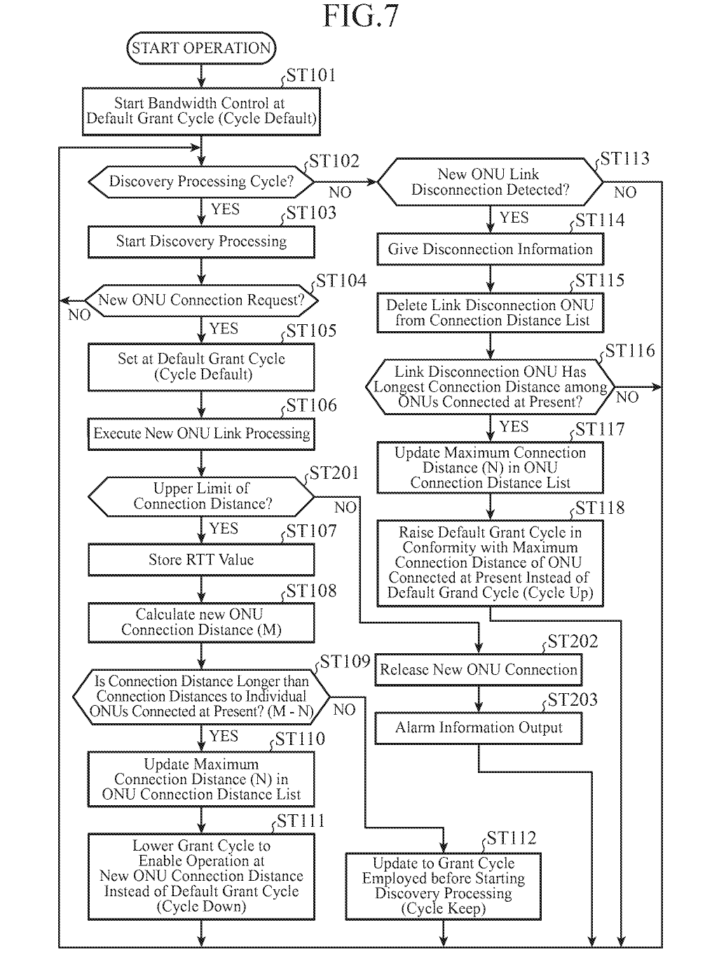

FIG. 7 is a flowchart illustrating the operation of the grant cycle alteration by the OLT 51 of the embodiment 2 in accordance with the present invention.

Incidentally, the same steps as those of FIG. 4 described in the embodiment 1 are designated by the same step numbers, and their redundant description will be omitted.

In FIG. 7, after the step ST106 described in FIG. 4, the processing from step ST201 to step ST203 is added.

As for step ST1 to step ST106, and step ST113 to step ST118, since they are the same as their counterparts described in FIG. 4, their description will be omitted.

In addition, it is also assumed in the embodiment 2 that a newly connected ONU is included in the ONUs 50 whose connection distance is altered.

When the discovery controller 9 detects a new ONU 50 at step ST106, the discovery controller 9 executes the connection processing (link processing) of the new ONU 50, measures the time (RTT) from sending a frame for confirmation to the new ONU 50 to receiving a response signal from the ONU 50 after that, and supplies the RTT value it measures to the RTT upper limit monitor 20. Incidentally, at this time, the discovery controller 9 gives a unique LLID to the newly connected ONU 50, and supplies it to the RTT upper limit monitor 20 together with the RTT value.

According to the RTT value it acquires from the discovery controller 9, the RTT upper limit monitor 20 decides whether or not the connection distance to the new ONU 50 the discovery controller 9 detects is not greater than the upper limit of the connection distance between the OLT 51 and the ONUs 50 (step ST201). In other words, the RTT upper limit monitor 20 decides whether the RTT value measured at step ST106 is within the preset upper limit of the RTT value or not.

If the RTT upper limit monitor 20 decides that the connection distance is within the upper limit at step ST201 (“YES” at step ST201), it informs the RTT storage 10 of the LLID information and RTT value of the new ONU 50, and the RTT storage 10 stores the RTT value and LLID after relating them to each other (step ST107).

After that, since the operation from step ST108 to step ST111 is the same as that of the embodiment 1 described with reference to FIG. 4, its detailed description will be omitted.

On the other hand, if the RTT upper limit monitor 20 decides that the connection distance is greater than the upper limit at step ST201 (“NO” at step ST201), that is, if it decides that the RTT value exceeds the preset upper limit, the RTT upper limit monitor 20 informs the discovery controller 9 that it exceeds the upper limit, and the discovery controller 9 relinquishes the connection of the new ONU 50 that exceeds the upper limit value (step ST202).

Then, the RTT upper limit monitor 20 delivers the alarm output information to the output unit (not shown) (step ST203), and returns to step ST102.

Incidentally, the alarm output information can be audio information so that the output unit can output a sound or voice, or can be optical information so that the output unit can blink or turn on a lamp. In addition, any other methods can be used as long as they inform that the connection of the new ONU 50 is released. In addition, as for the output unit, the OLT 51 can comprise it or an external device of the OLT 51 can comprise it.

As described above, according to the present embodiment 2, it further comprises the RTT upper limit monitor 20 so as to enable controlling the upper limit of the upstream data delay time by setting the maximum connection distance in addition to the function of optimizing the upstream data transmission delay implemented in the embodiment 1. In addition, by limiting the upstream maximum delay time dynamically by setting the limit to the connection distance to the ONUs 50, the present embodiment 2 can optimize the delay time in accordance with the connection distance to the ONUs 50 that are connected within the limited maximum delay time in the network that requires the upstream data transfer with less delay time.

Incidentally, it is to be understood that a free combination of the individual embodiments, variations of any components of the individual embodiments or removal of any components of the individual embodiments is possible within the scope of the present invention.

For example, in the embodiments 1 and 2 in accordance with the present invention, although the OLT 51 is described on the assumption that the PON system is a GE-PON, it may be a 10G-EPON corresponding to 10 Gpbs.

Incidentally, in the embodiments 1 and 2 in accordance with the present invention, although the configurations of the OLT 51 explained with reference to FIG. 3 and FIG. 6 are described on the assumption that their major object is to realize the operation of improving the delay time by altering the grant cycle time in accordance with the connection distance to the ONUs, the OLT 51 can be configured in such a manner that it further comprises other functional blocks such as a priority control unit.

In addition, as for the individual components described in FIG. 3 and FIG. 6 in the embodiments 1 and 2 in accordance with the present invention, although they can be implemented by elements and mechanical devices such as a CPU of a computer in terms of hardware, or by computer programs and the like in terms of software, their functional blocks are drawn here on the assumption that they can be implemented with the cooperation of the hardware and software. Accordingly, those skilled in the art will be able to understand that the functional blocks are implemented in various modes by combining hardware with software.

In addition, although the embodiments 1 and 2 assume that the OLT 51 has a configuration as described with reference to FIG. 3 or FIG. 6, it is enough that its configuration comprises the ONU connection processing unit 8 and the bandwidth controller 13.

### INDUSTRIAL APPLICABILITY

A station-side device in accordance with the present invention is capable of optimizing the communication delay time of the signal, and of improving the communication real time characteristics by reducing the upstream data communication delay time in accordance with the connection distance between the OLT 51 and the ONUs 50 of the PON system. Accordingly, it is applicable to an OLT that carries out bandwidth allocation to a plurality of ONUs connected to the OLT through an optical divider via optical fibers, and is applicable to a PON system which is an optical communication network comprising a single OLT and a plurality of ONUs.

### DESCRIPTION OF REFERENCE SYMBOLS

1 optical divider; 2 WDM unit; 3 received signal converter; 4 received data distributor; 5 data transmitter; 6 upper interface; 7 report receiver; 8 ONU connection processing unit; 9 discovery controller; 10 RTT storage; 11 connection distance monitor; 12 gate transmitter; 13 bandwidth controller; 14 grant cycle controller; 15 bandwidth request processing unit; 16 bandwidth allocation computing unit; 17 data receiver; 18 transmit data multiplexer; 19 transmit signal converter; 20 RTT upper limit monitor; 50 ONU; 51 OLT.

What is claimed is:

1. A station-side device connected to a plurality of subscriber devices through optical fibers, the station-side device comprising:
an ONU connection processor to calculate a connection distance to each one of the plurality of subscriber devices, and to output information about the connection distances; and
a bandwidth controller to alter a grant cycle, which is a cycle of performing bandwidth allocation to the plurality of subscriber devices, in accordance with the information about the connection distances the ONU connection processor outputs, and to control the bandwidth allocation on a basis of the grant cycle altered.

2. The station-side device according to claim 1, wherein
the ONU connection processor determines the maximum connection distance among the connection distances with the plurality of subscriber devices, and outputs information about the maximum connection distance; and
the bandwidth controller alters the grant cycle in accordance with the information on the maximum connection distance the ONU connection processor outputs.

3. The station-side device according to claim 2, wherein
the ONU connection processor computes the connection distances from RTT values of the plurality of subscriber devices obtained by discovery processing, and determines the maximum connection distance by comparing the connection distances calculated.

4. The station-side device according to claim 2, wherein
the bandwidth controller alters, when the bandwidth controller decides that the maximum connection distance reduces, the grant cycle in a manner as to reduce the grant cycle.

5. The station-side device according to claim 2, wherein
the bandwidth controller alters, when the bandwidth controller decides that the maximum connection distance lengthens, the grant cycle in a manner as to increase the grant cycle.

6. The station-side device according to claim 2, wherein
the ONU connection processor comprises:
a discovery controller to perform regular monitoring based on a discovery cycle, and to measure an RTT value corresponding to time from transmission of an acknowledgement signal to each one of the plurality of subscriber devices to reception of a response signal;
an RTT storage to store the RTT value the discovery controller measures by associating the RTT value with an LLID which is a unique number for identifying each of the plurality of subscriber devices; and
a connection distance monitor to calculate the connection distance to each one of the plurality of subscriber devices connected in accordance with the RTT value the RTT storage stores, to determine the maximum connection distance among the connection distances, and to output information about the maximum connection distance, and wherein
the bandwidth controller comprises:
a grant cycle controller to alter grant cycle time in accordance with information on the maximum connection distance acquired from the connection distance monitor;
a bandwidth request processor to collect a bandwidth allocation request from the plurality of subscriber devices; and
a bandwidth allocation computer to control the bandwidth allocation in accordance with the grant cycle time the grant cycle controller alters, the bandwidth allocation request the bandwidth request processor collects, and the RTT value and the LLID received from the RTT storage.

7. The station-side device according to claim 6, wherein
the bandwidth request processor collects the bandwidth allocation request by receiving a report from each one of the plurality of subscriber devices; and
the bandwidth allocation computer controls the bandwidth allocation by sending a gate signal to each one of the plurality of subscriber devices at every grant cycle.

8. The station-side device according to claim 6, wherein
the ONU connection processor further comprises an RTT upper limit monitor to decide whether the RTT value the discovery controller detects is within a preset upper limit or not; and
the discovery controller releases, when the RTT upper limit monitor decides that the RTT value exceeds the upper limit, a connection with the subscriber device as to which a decision is made that the RTT value exceeds the upper limit.

9. A PON system in which a single station-side device is connected with a plurality of subscriber devices through optical fibers, and the station-side device performs bandwidth allocation to be used for communication to the plurality of subscriber devices, wherein
the station-side device comprises:
an ONU connection processor to calculate a connection distance to each one of the plurality of subscriber devices, and to output information about the connection distances; and
a bandwidth controller to alter a grant cycle, which is a cycle of performing bandwidth allocation to the plurality of subscriber devices, in accordance with the information about the connection distances the ONU connection processor outputs, and to control the bandwidth allocation on a basis of the grant cycle altered.
